(19) United States
(12) Patent Application Publication
(10) Pub. No.: US 2022/0254190 A1
(43) Pub. Date: Aug. 11, 2022

(54) Systems and Methods Using Person Recognizability Across a Network of Devices

(71) Applicant: Google LLC, Mountain View, CA (US)

(72) Inventors: Andrew Gallagher, Fremont, CA (US); Joseph Edward Roth, Longmont, CO (US); Michael Christian Nechyba, Pittsburgh, PA (US)

(21) Appl. No.: 17/622,460

(22) PCT Filed: Aug. 14, 2019
(86) PCT No.: PCT/US2019/046452

§ 371 Date: Dec. 23, 2021

(51) Int. Cl. G06V 40/16; G06V 40/50; G06V 10/70; G06F 16/583

(52) U.S. Cl. CPC G06V 40/172; G06F 16/583; G06V 10/70; G06V 40/50

(57) ABSTRACT

The present disclosure is directed to computer-implemented systems and methods for performing recognition over a network of devices. In general, the systems and methods implement a machine-learned recognizability model that can process information such as a person's voice, facial characteristics, or similar information to determine a recognizability score without necessarily generating or storing biometric information that could be used to identify the person. The recognizability score can act as a proxy for the quality of the information as a reference for biometric recognition that can be performed on other devices in the network of devices. Thus a single device can be used to enroll a person in the network (e.g., by capturing a number of photographs of the person). Thereafter, connection to the other devices can utilize a sensor (e.g., a camera) on the other devices to compare features of the reference information to the input received by the sensor.

### FIELD

The present disclosure relates generally to machine learning. More particularly, the present disclosure relates to an enrollment process (e.g., using machine-learned models) which enables user recognition to occur across a network of devices while limiting biometric analysis to certain trusted devices.

### BACKGROUND

Biometric recognition such as facial recognition, fingerprint recognition, and voice recognition has been implemented in various devices including smart phones and personal home assistants. Often these recognition methods are used as a form of authentication to control permissions for accessing the device or certain features of the device.

As the number of computing devices grows, especially network connectable devices which can generally be referred to as “smart” devices and/or the Internet of Things (IoT), there exists a corresponding need to define access permissions on a per-device basis.

Typically, to enable biometric recognition, a user can participate in an enrollment process, which may include generation of one or more reference files (e.g., reference images, fingerprint scans, voice samples, etc.) for the user. However, as the number of smart computing devices grows, redundant performance in this enrollment process for each separate device can become time-consuming, cumbersome, or otherwise frustrating for the user. Thus, when a user adds a new device to her network of devices, she may wish to simply extend the ability to recognize her identity to such new device without needing to again perform the enrollment process.

Needed in the art are methods and systems that can advantageously manage biometric recognition across a network of devices.

### SUMMARY

The present disclosure is directed to computer-implemented systems and methods for performing recognition over a network of devices. In general, the systems and methods implement a machine-learned recognizability model that can process information such as a person's voice, facial characteristics, or similar information to determine a recognizability score without necessarily generating or storing biometric information that could be used to identify the person. The recognizability score can act as a proxy for the quality of the information as a reference for biometric recognition that can be performed on other devices in the network of devices. Thus a single device can be used to enroll a person in the network (e.g., by capturing a number of photographs of the person). Thereafter, connection to the other devices can utilize a sensor (e.g., a camera) on the other devices to compare features of the reference information to the input received by the sensor.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs recognition across a network of devices according to example embodiments of the present disclosure.

FIG. 1B depicts a block diagram of an example computing device that can be used to implement recognition and/or enrollment in recognition according to example embodiments of the present disclosure.

FIG. 1C depicts a block diagram of an example computing device that can be used to implement recognition and/or enrollment in recognition according to example embodiments of the present disclosure.

FIG. 2 depicts an illustration of an example network of devices according to example embodiments of the present disclosure.

FIG. 3 depicts a block diagram of an example network of devices according to example embodiments of the present disclosure.

FIG. 4 depicts a flow chart diagram of an example method for performing enrollment in a network of devices according to example embodiments of the present disclosure.

FIG. 5 depicts a block diagram displaying an example process for training a recognizability model according to example embodiments of the present disclosure.

Reference numerals that are repeated across plural figures are intended to identify the same features in various implementations.

### DETAILED DESCRIPTION

### Overview

Generally, the present disclosure is directed to computer-implemented systems and methods for performing recognition over a network of devices. In particular, as described above, when a user adds a new device to her network of devices, she may wish to simply extend the ability to recognize her identity to such new device without needing to again perform the enrollment process. Aspects of the present disclosure enable such a process by capturing and storing reference files (e.g., a gallery of reference images) for a user at one or more first devices (e.g., a user's device such as a smartphone and/or a server computing system). Thereafter, when a user wishes to extend identity recognition to a second device (e.g., a new home assistant device), the user can simply instruct the first device(s) to share the reference file(s) with the second device(s). In such fashion, a user can quickly and easily enroll a new device (e.g., enable the new device to perform a recognition process to recognize her), without needing to again perform an enrollment process in which the reference file(s) are collected. Furthermore, additional aspects of the present disclosure are directed to the use of machine-learned models to facilitate the enrollment and recognition processes. Specifically, aspects of the present disclosure can include the use of a machine-learned recognizability model (e.g., at or by the first device(s) such as the user device and/or the server device) which enables the curation of high-quality reference files without the computation of biometric or other personally identifiable information about the user.

More particularly, according to one aspect of the present disclosure, one or more of the devices participating in the network can include and employ a machine-learned recognizability model that can process information such as a person's voice, facial characteristics, or similar information to determine a recognizability score without necessarily generating or storing biometric information that could be used to identify the person. In general, the recognizability score can act as a proxy for the quality of the information as a reference for biometric recognition that can be performed on other devices in the network of devices.

Without subscribing to any one definition of quality or recognizability, generally these terms are used to indicate that the condition of identifying data (images or voice) displays sufficient detail to distinguish between individuals. For example, the more information contained in an image or audio file that is related to the individual performing enrollment, generally the higher the quality of the file. As an example, an image file displaying only the upper half of a face is of lower quality compared to an image file displaying the entire face. As another example, an audio file containing a voice recording obtained in a quiet room is of higher quality compared to a voice recording obtained outdoors or in a crowded environment. Thus, generally recognizability can be connected to both the amount of data as well as data properties such as low background relative to the identifying features. For instance, low-recognizability can be connected to lower amounts of data and/or files displaying higher background features.

Other definitions for recognizability can be tied to the query. As an example, high recognizability can be used to indicate that for a query signal with high recognizability and an unknown identity, there is a greater probability (e.g., 75% or greater) that the identity can be accurately determined when provided with a gallery of signals (images) of known identity. The converse of this example may also be used to define examples of low recognizability. A recognizability score may thus be used to indicate a probability that identity may be accurately determined from an image or other file.

Thus, in some implementations, newly captured reference files (e.g., images captured by a user's device as part of the initial enrollment process) can be evaluated by the machine-learned recognizability model to determine to a recognizability score that indicates the extent to which such file (e.g., image) is useful to recognize the individual depicted or referenced by the file. However, the recognizability score does not itself contain biometric information or other information which enables identification of the individual. Instead, the recognizability score simply indicates whether the file would be useful to perform recognition via a separate recognition process, which may be performed by a different device (e.g., a “secondary” device to which the user later requests that her identity be extended).

Certain of the newly captured reference files can be selected, based on the respective recognizability scores) for inclusion in a set of reference file(s) that will serve as reference file(s) for use in recognition of the user moving forward. As one example, newly captured images (e.g., images captured by a user's device as part of the initial enrollment process) can be evaluated by the machine-learned recognizability model to determine to a recognizability score for each image. The images that receive a recognizability score that satisfies a certain threshold score (e.g., that are adjudged to have high “recognizability”) can be selected (e.g., by the user's device and/or a server device) and stored (e.g., by the user's device and/or the server device) in an image gallery associated with the user. Importantly, however, while the set of reference file(s) can be built using the recognizability analysis (e.g., to produce a high-quality reference set that includes only reference file(s) that are highly useful for performance of a recognition process), computation of actual biometric information does not necessarily occur to produce the set of reference file(s). Thus, high quality reference sets can be built even in instances in which the first device(s) (e.g., the user's device) are prohibited (e.g., due to policy constraints, permissions, or otherwise) from computing or storing biometric information.

Upon a user's request to do so, this image gallery can then be shared with or made accessible to a new secondary device (e.g., a home assistant device) to which the user wishes to extend recognition capabilities. In particular, in some implementations, the secondary device can include and/or employ a machine-learned recognition model to recognize the user based at least in part on the reference file(s) (e.g., the image gallery).

More particularly, another aspect of the present disclosure relates to the use of a machine-learned recognition model (separate from the recognizability model) which does operate to recognize the individual (e.g., through computation or analysis of biometric information). Specifically, a secondary device can include one or more sensors (e.g., camera, microphone, fingerprint sensor, etc.) that capture additional files (e.g., images, audio, etc.) that depict or otherwise represent a person. The secondary device can employ the machine-learned recognition model to analyze the additional files and the reference file(s) to determine whether the person represented by the additional files can be recognized as the user, or not. As one example, the machine-learned recognition model can be a neural network that has been trained (e.g., via a triplet training technique) to produce embeddings (e.g., at a final layer and/or at one or more hidden layers) that are useful for performing recognition. For example, a triplet training scheme can be used to train a machine-learned recognition model to produce respective embeddings for respective inputs, where a distance (e.g., L2 distance) between a pair of embeddings is representative of a probability that the corresponding pair of inputs (e.g., images) depict or otherwise reference the same person. Thus, in some implementations, the machine-learned recognition model can produce embedding(s) for the additional file(s) and the reference file(s) and can compare the respective embeddings to determine whether the person represented by the additional files can be recognized as the user, or not.

Another aspect of the present disclosure which is described in further detail elsewhere herein relates to the training of the machine-learned recognizability model based on the machine-learned recognition model using a distillation training technique. In particular, the distillation training technique leverages the fact that hidden layer output(s) from one or more hidden layer(s) of the machine-learned recognition model contain, in addition to biometric information regarding the input, information about the recognizability of the input. Furthermore, computation of a metric (e.g., a norm or other cumulative statistic) associated with the hidden layer output(s) may remove or destroy the biometric or personally identifiable information, while retaining the recognizability information. Thus, in some implementations, the machine-learned recognizability model can be trained to predict a norm or other metric of one or more hidden layer output(s) from one or more hidden layer(s) of the machine-learned recognition model. In such fashion, the machine-learned recognizability model can be trained to produce recognition scores that are indicative of recognizability but are exclusive of or otherwise do not contain biometric data or other personally identifiable information.

Thus, in some example implementations, a single device can be used to enroll a person in the network (e.g., by capturing a number of photographs of the person). Thereafter, connection to the other devices can utilize a sensor (e.g., a camera) on the other devices to compare features of the reference information to the input received by the sensor, to perform recognition of the person.

Implementations of the disclosure may provide advantages for defining device access policies across a network of connected devices. This can be especially useful as the number of Internet of Things (IoT) devices continues to expand and defining permissions on a per-device basis becomes onerous. Rather than enrolling each device in voice, face, fingerprint, or other biomarker recognition; a single enrollment can be performed that determines high quality information to select as a reference. A person attempting to access one of the devices in the network can then undergo a recognition analysis (e.g., using a trained machine learning recognition model) that compares newly captured data obtained by such additional device to the reference file(s). In such manner, the user can avoid redundant performance of an enrollment process for multiple different devices. Eliminating redundant performance of the enrollment process can conserve computing resources (e.g., process usage, memory usages, network bandwidth, etc.), because the process is only performed once, rather than multiple times.

As an example for the purpose of illustration, a person wanting to set up a smart home that includes features such as a home assistant, keyless entry, and/or additional devices that utilize biometric features (e.g., fingerprint, eye, face, voice, etc.) may want to set facial recognition as an access policy for interacting with each of the devices or for accessing certain capabilities of the devices. To accomplish the enrollment process over the network of devices, the person can capture one or multiple images with a personal computing device (e.g., a smartphone) including software or hardware implementing methods in accordance with the disclosure. The personal computing device can apply the recognizability model to determine which of the one or more images (if any) to transmit to a server or other centralized computing system (e.g., a cloud network) as a reference file. In general, the centralized computing system can communicate with each of the devices so that data can be transmitted over a network (e.g., the internet, Bluetooth, LAN, etc.) between each of the devices and the centralized computing system. Thereafter accessing each device can be performed according to each device's policies. For instance, accessing a device can include using a recognition model included in the device to compare input data received by a device sensor such as a camera in the case of facial recognition to one or more reference files.

An example implementation of the present disclosure can include a method for enrolling in personal identification across a network of devices. In general, the method includes obtaining a dataset which includes one or more files representative of a person (e.g. images of a face, fingerprint, eye, or similar information and/or voice recordings). From these one or more files, a machine-learned recognizability model (e.g., a distillation model) can determine a recognizability score for each of the one or more files by providing the files to the machine-learned recognizability model. Based at least in part on the recognizability score(s), a portion of the dataset can be selected to store on one or more of the devices as a reference file or files. Thereon, attempting to access one of the devices included in the network can include a recognition step. As an example, implementing the recognition step can include obtaining sensor information descriptive of the person trying to access the device (e.g., using a camera or microphone). This sensor information can be compared to the reference file or files to determine if biometric information indicates a match that would allow access to the device, an application on the device, or a combination of both.

Aspects of the method for enrolling in personal identification can include obtaining the dataset including one or more files representative of a person using a first device included in the network of devices. In some implementations, the first device can include a personal computing device such as a smart phone or personal computer that can include built-in components such as a camera or other image capture device and/or a microphone. Additional features of the first device can include an image processor that may be configured to detect if one or more persons are present in an image. For brevity, implementations of the disclosure are discussed using one person as an example use case; however, this does not limit these or other implementations to only enrolling a single person or images that contain a single person. Image filters or other image processing that can be accessed by one or more of the devices may be used to segment the image into individual identities (separate detected persons) for performing enrollment.

Another aspect of enrolling in personal identification includes determining a recognizability score for each of the one or more files. In an example implementation, the recognizability score can be determined using a recognizability model that has been trained using distillation and may be referred to as a distillation model. As an example, a recognizability model according to the present disclosure may include a distillation model trained from one or more outputs of one or more other neural networks. The distillation model can provide advantages such as lower computing costs that may allow the distillation model to be executed on a personal computing device such as a laptop or smart phone.

Training the distillation model can include obtaining a neural network and/or one or more outputs of a neural network. The neural network can be used to generate outputs that include one or more hidden layers by providing an input (e.g., an image of a face) to the neural network. Since each of the hidden layers can include one or more features, a metric (e.g., norm) can be calculated from the one or more hidden layers. Training the distillation model can then include optimizing an objective function for predicting the metric calculated from the one or more hidden layers determined for a given input.

For instance, an example method for training the distillation model can include: obtaining a neural network configured to determine a series of hidden layers; determining a plurality of outputs by providing a plurality of inputs to the neural network, where each output is associated with a respective input, and where each output includes a portion of the series of hidden layers; calculating a metric for at least one hidden layer included in the portion of the series of hidden layers; and training the distillation model to predict the metric based at least in part on receiving the respective input.

Aspects of the neural network can include a network configuration describing the number of hidden layers that the neural network is configured to determine. For example, the neural network can be configured to determine at least three layers such as at least 5 hidden layers, at least 7 hidden layers, at least 10 hidden layers, at least 20 hidden layers, and so on. In general, the at least one hidden layer or layers used to calculate the metric does not include the first layer or the last layer of the layers. Thus for training the distillation model, generally a middle layer of the neural network can be selected for calculating the metric. As an example for illustration, the penultimate layer (i.e., the second to last layer) can be selected as the hidden layer for calculating the metric. Additionally, in some instances, the neural network may be configured to limit determining the output. For example, since a middle layer of the neural network can be selected for calculating the metric, the subsequent layers of the neural network need not be calculated, and the neural network may be configured to stop determining further hidden layers or other outputs of the neural network.

Using a distillation model may provide certain advantages as the distillation model can perform recognizability analysis without necessarily generating biometric information that could otherwise be used to identify the person. This can provide an advantage for users since they do not need to familiarize themselves with the policies or capabilities of every device included in the network of devices. The user can instead allow each device to operate according to its own policies. Additionally, a distillation model can provide a more light-weight implementation that can be implemented on a user device to more quickly identify and/or select reference files.

A further example aspect of implementations of the disclosure can include selecting, based at least in part on the recognizability score, a portion of the dataset to store as a reference file or files. According to certain implementations, the reference file can be accessed as a proxy for comparison to a person attempting to access one of the devices included in the network. Thus, selection can be optimized, in some cases, to reduce false positive (e.g., where a device allows a person to access the device, when the person has not enrolled), to reduce false negatives (e.g., where the device prevents a person from accessing the device, when the person has enrolled), or a combination of both. For example, implementations of the disclosure may provide advantages for reducing false negatives that can result from built-in image or voice comparison models that are present on the device that a person is attempting to access. The recognizability model can determine or otherwise identify high-quality information representative of the person during the enrollment process and in some cases may even prompt a user trying to perform enrollment that none of the files included in the dataset meet a recognizability standard or threshold. As another example, implementations of the disclosure can provide advantages for reducing false positives by only selecting high quality images. For instance, if a person were to enroll hypothetically with a blurry image, then identifying information may be obscured making it easier for a different person to access the device. Generally, the more obscured an image is, the less identifying features it would include, leading to a higher likelihood for false positives.

In some implementations, the threshold can be determined by a metric such as a percentile, minimum, maximum, or other similar aggregate measure determined from the recognizability scores for the one or more files. Additionally or alternatively, the threshold may include a preset value and all or a set number of files that meet or exceed the value can be selected as the portion of the dataset to store as reference file(s). Including a preset value can provide advantages for cases when the files captured during enrollment include low-quality data and comparing the recognizability score for each of the files to the threshold indicates that none of the scores meet or exceed the threshold. In these instances, the device performing enrollment may provide a prompt to the user such as displaying a message on the device that enrollment should be repeated or that additional files need to be included in the dataset. Another example advantage of performing enrollment on the first device can include saving and/or reducing network traffic since the first device can determine which (if any) files meet the threshold for selection. Then only those files that were selected can be transmitted (e.g., to a second device in the network of devices) instead of transmitting the entirety of files obtained. For instance, there may be cases where none of the files meet the threshold and so none of the files need to be transmitted to other devices included in the network.

For files having recognizability scores that meet or exceed the threshold, these can be transmitted to a second device for storage as the reference file(s). In some implementations, the second device can include a server, a cloud-computing device, or similar device that may be accessed by each device in the network of devices. Having this centralized reference can provide advantages such as reducing data storage and/or providing easier enrollment updates such as persons authorized to access a device.

As an example implementation, a person attempting to access a device included in the network of devices and/or an operation/application performed by the device may undergo a biometric analysis on the device. The biometric analysis can include accessing a sensor included on the device to obtain a signal including information about the person attempting to access the device (e.g., video from a camera, audio from a microphone, etc.) This signal can be processed by a biometric analyzer such as a machine-learned recognition model trained to determine a set of features associated with the person (e.g., facial characteristics). The same biometric analyzer or a similarly trained biometric analyzer can process the reference file(s) to determine a reference set of features. These two sets of features can then be compared and, based on the comparison, a response may be provided to the person attempting to access the device. For instance, if the person attempting to access the device has completed enrolling in the network of devices, the response can include opening a home screen of the device or performing an operation/application included on the device. Alternatively, if the person attempting to access the device has not enrolled in the network of devices, the response can include prompting the person to perform enrollment, providing the person with an error, and/or sending a notification to person(s) having performed enrollment.

In general, the biometric analyzer can be included in one or more of the devices included in the network of devices and may be configured to perform biometric analysis according to the device's polices. For example, a third device included in the network of devices may include a computer assistant such as a Google Home or other similar devices configured to receive a natural language input and generate an output based on the input. Each of these devices may include their own models (e.g., machine-learned recognition models) for performing biometric recognition. For instance, the machine-learned model can implement a neural network to generate an embedding describing a feature representation of the person attempting to access the device. These devices can also include one or more sensors for obtaining a signal that includes information describing the person attempting to access the device.

As an example of technical effect and benefit, the methods and systems for performing recognition across a network of devices can provide greater control and reduce computing resources to manage and update access policies. For example, rather than individually updating each device included in the network, time and computing resources can be saved by only performing one enrollment. Additionally, the one enrollment can determine high-quality information so that the need to reenroll or the likelihood for a false negative or false positive is diminished. Likewise, the recognizability analysis described herein can be performed (e.g., by the secondary device such as the home assistant device) at recognition time, in addition to during enrollment. Use of the recognizability analysis at recognition time can save computing resources by preventing the recognition analysis from being performed on poor quality files (e.g., images) with low recognizability.

Generally, implementations of the disclosure can include or otherwise access a recognizability model to perform recognizability analysis. For certain implementations, the recognizability model can be trained using distillation and may be referred to as a distillation model. For example, a recognizability model according to the present disclosure may include a distillation model trained from output from one or more neural networks. The distillation model can provide advantages such as lower computing costs that may allow the distillation model to be executed on a personal computing device such as a laptop or smart phone. In particular, a distillation model as described herein can be a specialized model that is very fast and lightweight, thereby conserving computing resources such as processor and memory usage.

With reference now to the Figures, example embodiments of the present disclosure will be discussed in further detail.

### Example Devices and Systems

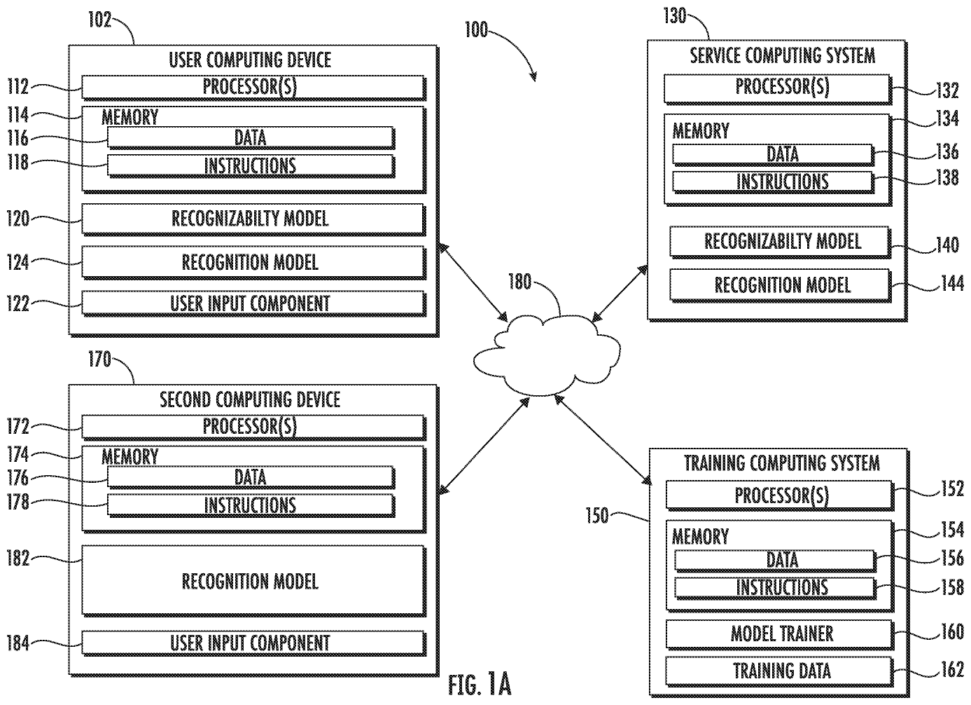

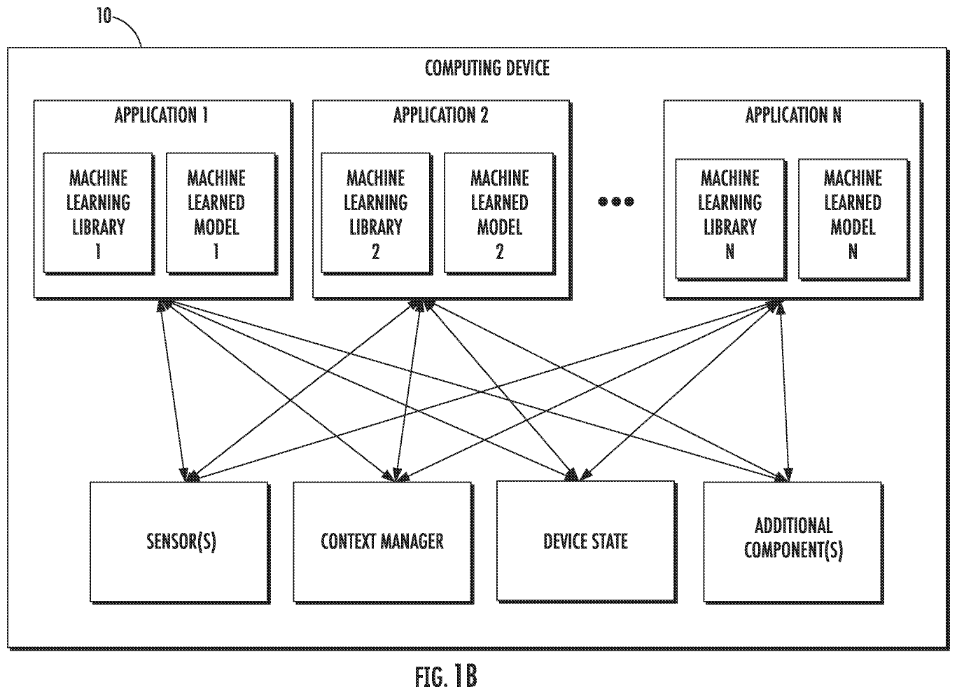

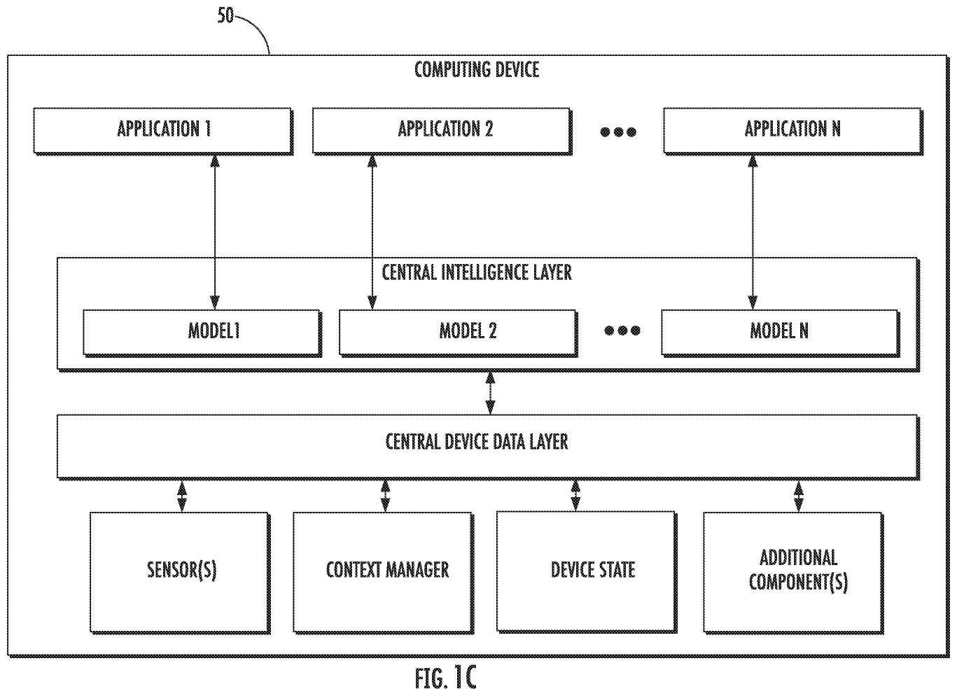

FIG. 1A depicts a block diagram of an example computing system 100 that can perform enrollment in a network of devices according to example embodiments of the present disclosure. The system 100 includes a user computing device 102, a server computing system 130, a training computing system 150, and a secondary computing device 170 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, a home assistant (e.g., Google Home or Amazon Alexa) or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more recognizability models 120. For example, the recognizability models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more recognizability models 120 can be received from the server computing system 130 over network 180, stored in the user computing device memory 114, and then used or otherwise implemented by the one or more processors 112. In some implementations, the user computing device 102 can implement multiple parallel instances of a single recognizability model 120 (e.g., to perform parallel enrollments and/or determine recognizability scores across multiple instances of the recognizability model 120).

More particularly, the recognizability model can include a machine-learned model that has been trained using a distillation technique to process identifying information such as the pixels of a person or face and/or the signal of a voice to determine whether the information is recognizable. In general, the person recognizability analyzer can be configured to not compute or store any biometric information such as face embeddings, voice embeddings, facial landmarks such as the eyes or the nose, or vocal features such as accent. This aspect of the recognizability model can be achieved by training the recognizability model to output a recognizability score that corresponds to the quality of the input information.

Additionally or alternatively, one or more recognizability models 140 can be included in or otherwise stored and implemented by the server computing system 130 that communicates with the user computing device 102 according to a client-server relationship. For example, the recognizability models 140 can be implemented by the server computing system 140 as a portion of a web service. Thus, one or more models 120 can be stored and implemented at the user computing device 102 and/or one or more models 140 can be stored and implemented at the server computing system 130.

In certain implementations, the user computing device may also include a recognition model 124. The recognition model 124 can include a machine-learned model (e.g., a trained neural network) for performing biometric recognition. In general, the recognition model 124 is different from the recognizability model 120 as the recognition model 124 can generate and/or store biometric information (e.g., facial characteristics such as pupillary distance) that could be used to identify an individual. In some implementations, the recognition model 124 may not be included as part of the user computing device 102. Instead a recognition model 144 stored as part of another computing system such as a server computing system 130 may be accessed by the user computing device 102.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a camera, a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned recognizability models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks.

Additionally, in certain implementations the server computing system 130 can store or otherwise include one or more machine-learned recognition models 144. As described above, the recognizability model 130 and the recognition model 144 may be differentiated by the capability to store or generate biometric information. In general, the recognizability model 140 can be used as a filter to determine whether information provided to the model includes sufficient detail or quality for performing biometric recognition (e.g., using the recognition model 144).

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The secondary computing device 102 can be any type of computing device, such as, for example, a personal computing device (e.g., laptop or desktop), a mobile computing device (e.g., smartphone or tablet), a gaming console or controller, a wearable computing device, an embedded computing device, a home assistant (e.g., Google Home or Amazon Alexa) or any other type of computing device. In general, the secondary computing device can include one or more processors 172, memory 174, a recognition model 182, and a user input component 184. In an example implementation, the secondary computing device 170 can be an IoT device that can include an AI assistant such as a Google Home. Additionally, while illustrated as a single secondary computing device 170, the secondary computing device 170 can represent one or more connected devices that include a recognition model 182 for performing biometric recognition (e.g., facial recognition, voice recognition, fingerprint recognition, etc.) One aspect of the secondary computing device 170 is that this device need not include a recognizability model 120 or 140 for determining a recognizability score. Instead the secondary computing device 170 may access reference files (e.g., as data 136 stored on the server computing system 130 or data 116 stored on the user computing device) that were selected based at least in part on recognizability scores determined by the recognizability model(s) 120 and/or 140 included in the user computing device 120 and/or the server computing system 130. In this manner, a user attempting to access the secondary computing device 170 need not perform an enrollment for each secondary computing device 170.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the recognizability models 120 and/or 140 based on a set of training data 162. The training data 162 can include, for example, output from one or more machine-learned models, such as models configured to perform facial of voice recognition. These one or more machine-learned models can include neural networks configured to generate 3 or more hidden layers. In an example implementation, the recognizability models 120 and/or 140 can be trained using features of the hidden layer(s) generated by one or more neural networks rather than the output of the neural networks. Additionally, in some cases the features of the hidden layers may be summarized using a metric (e.g., norm) and the recognizability models 120 and/or 140 trained using training data 162 that includes the metric. For instance, learning a distilled model for facial recognition can utilize a network that inputs small thumbnail images and directly regresses to the metric (e.g., L2 Norm value) determined from the penultimate hidden layer.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some implementations, the user computing device 102 can implement the model trainer 160 to personalize the models 120 based on user-specific data.

FIG. 1B depicts a block diagram of an example computing device 10 that can perform enrollment across a network of devices according to example embodiments of the present disclosure. The computing device 10 can be a user computing device or a server computing device.

The computing device 10 can include a number of applications (e.g., applications 1 through N). Each application can contain its own machine learning library and machine-learned model(s). For example, each application can include a machine-learned model. Example applications include a text messaging application, a personal assistant application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Model Arrangements

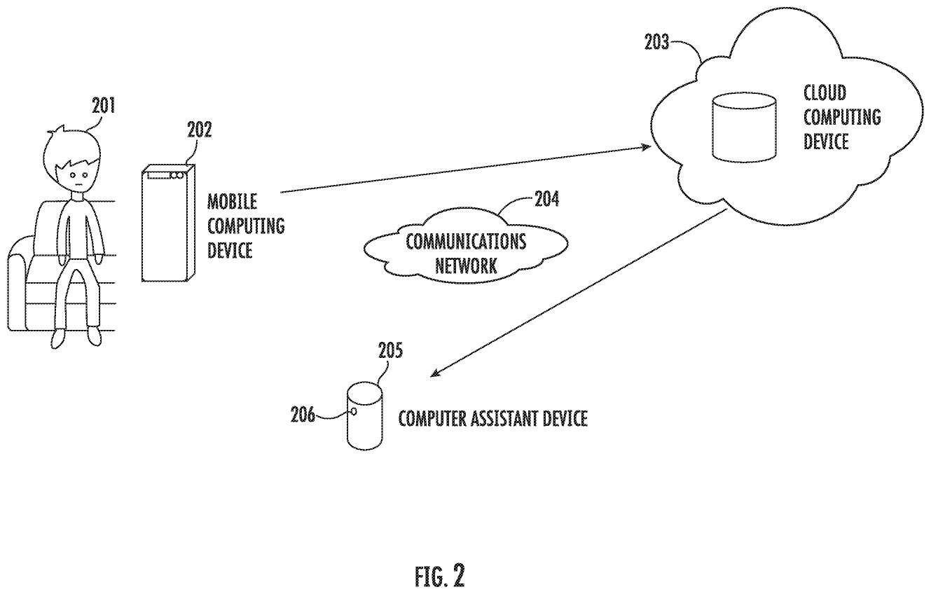

FIG. 2 depicts an illustration of an example network of devices according to example embodiments of the present disclosure. As shown in the figure, the network of devices can include at least three devices such as a mobile computing device 202, a cloud or server computing device 203, and an auxiliary or secondary device 205 such as a computer assistant device. The secondary device 205 can also include a sensor 206 such as a camera or microphone for obtaining information (e.g., new files such as new images). In an example implementation, a person 201 performing enrollment in the network of devices may use a mobile computing device 202 to obtain a dataset including one or more files representative of the person 201. For example, these files can include pictures, sound, or other identifying information. At the mobile computing device 202 or the cloud computing device 203, a recognizability model may be used to determine which of the files, if any, should be transferred over the communications network 204 for storage as a reference file on the cloud computing device 203. After enrollment, when the person 201 requests to enroll another device included in the network, such as the computer assistant device 205, the computer assistant device 205 may access or receive the reference file(s) from the mobile computing device 202 and/or cloud computing device 203 to perform a biometric analysis (e.g., using a machine-learned recognition model).

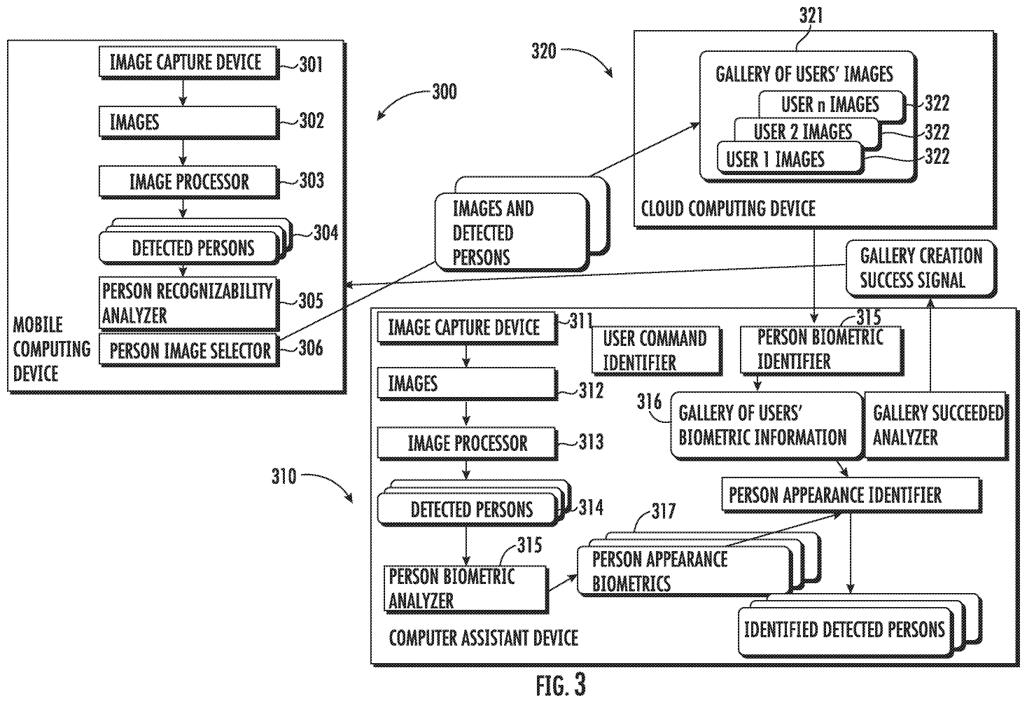

FIG. 3 depicts a block diagram of an example network of devices according to example embodiments of the present disclosure. FIG. 3 provides an example case of FIG. 2, where each of the at least three devices are shown as including certain components or performing certain operations. In FIG. 3, a mobile computing device 300 is illustrated as including an image capture device 301 for obtaining images 302 representative of a person performing enrollment in the network of devices. These images 302 can be provided to an image processor 303 to identify or otherwise group the images 302 into detected persons 304 for instances when the images 302 contain more than one person. For example, the image processor 303 can apply an object detection model or process to detect persons in the images 302.

The groupings of detected persons 304 can then be provided to a person recognizability analyzer 305 such as a machine-learned distillation model or recognizability model described herein. Based at least in part on recognizability scores determined by the person recognizability analyzer 305, a person image selector 306 may separately determine images and selected persons to transmit to the cloud computing device 320 as reference images 322 included in a gallery 321 that can be created for a specific user or person. Though shown in FIG. 3 as two separate features, the person recognizability analyzer 305 and the person image selector 306 may be implemented as a single operation of the recognizability model and logic associated therewith. Likewise, although components 303-306 are shown at the mobile computing device 300, some or all of these components could instead be included or performed at the cloud computing device 320.

Also depicted in FIG. 3 is a third device, which is shown as a computer assistant device 310. This device 310 is illustrated as including an image capture device 311 that can be used for obtaining additional images 312 representative of a person attempting to access the device 310 or an application performed by the device 310. The device 310 also includes a person biometric analyzer 315 which can perform biometric analysis on images (e.g., images 312 and/or images 322) to analyze biometric information associated with the images. For example, the person biometric analyzer 315 can include or employ a machine-learned recognition model as described herein. One example recognition model is FaceNet, its derivatives, and similar. See, Schroff et al., FaceNet: A Unified Embedding for Face Recognition and Clustering (https://arxiv.org/abs/1503.03832), which provides an example triplet training process which can be used to train a recognition model to produce pairs of embeddings for pairs of inputs where distances directly correspond to a measure of face similarity in the inputs.

While the computer assistant device 310 is shown as including an image processor 313 to detect one or more persons 314, these elements need not be present, and images 312 taken by the image capture device 311 may be directly input to a person biometric analyzer 315 to determine person appearance biometrics such as embeddings, measurements or locations of distinctive features, etc. The same or a different biometric analyzer 315 may be used to process the user reference images 322 to determine biometric information 316 from the gallery of users' images 321 which can be compared to the person appearance biometrics 317 for example using a person appearance identifier (e.g., which may compare respective embeddings (e.g., a distance therebetween), respective features, etc.) to generate a confidence score for identifying whether certain persons depicted in the images 312 are also included in the gallery of users' images 321.

### Example Methods

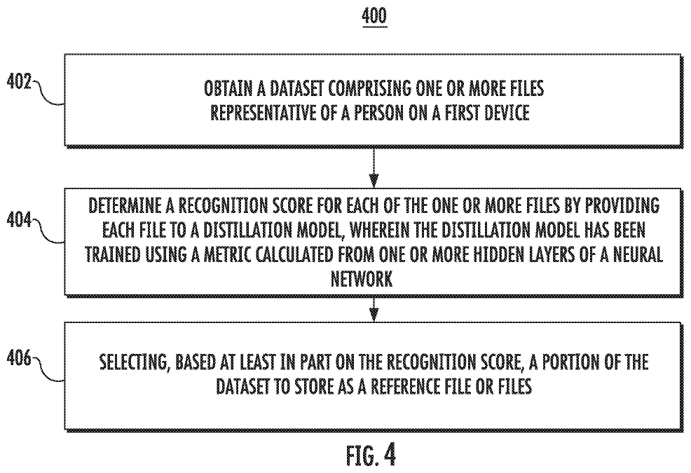

FIG. 4 depicts a flow chart diagram of an example method to perform according to example embodiments of the present disclosure. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

At 402, a computing system can obtain a dataset including one or more files representative of a person on a first device. The first device can include a personal computing device such as a smart phone or personal computer having built-in components such as a camera or other image capture device and/or a microphone. Additional features of the first device can include an image processor that may be configured to detect if one or more persons are present in an image.

At 404, the computing system can determine a recognizability score for each of the one or more files by providing each file to a distillation model, the distillation model having been trained using a metric calculated from one or more hidden layers of a neural network. Generally, the recognizability score can be computed before transmitting the files to a second device. Thus the recognizability model may be implemented on the first device or otherwise accessed by the first device to determine the recognizability scores. Though preferable to minimize storage and computing costs, a cloud service may automatically upload any files generated on the first device to a second device (e.g., a server). Thus in some implementations, determining the recognizability scores may be performed on the second device.

At 406, the computing system can select, based at least in part on the recognizability score, a portion of the dataset to store as a reference file or files. In general, selecting the portion of the dataset to store as the reference file(s) can include transmitting the reference file(s) to a second device. Alternatively or additionally, selecting may include designating a reference location for storing the reference file(s) such as a gallery of users' images or recordings that can be accessed by other devices included in the network. In this manner, files that are directly uploaded to the second device may be filtered so that only designated reference file(s) can be accessed during biometric recognition when a person is attempting to access a device included in the network.

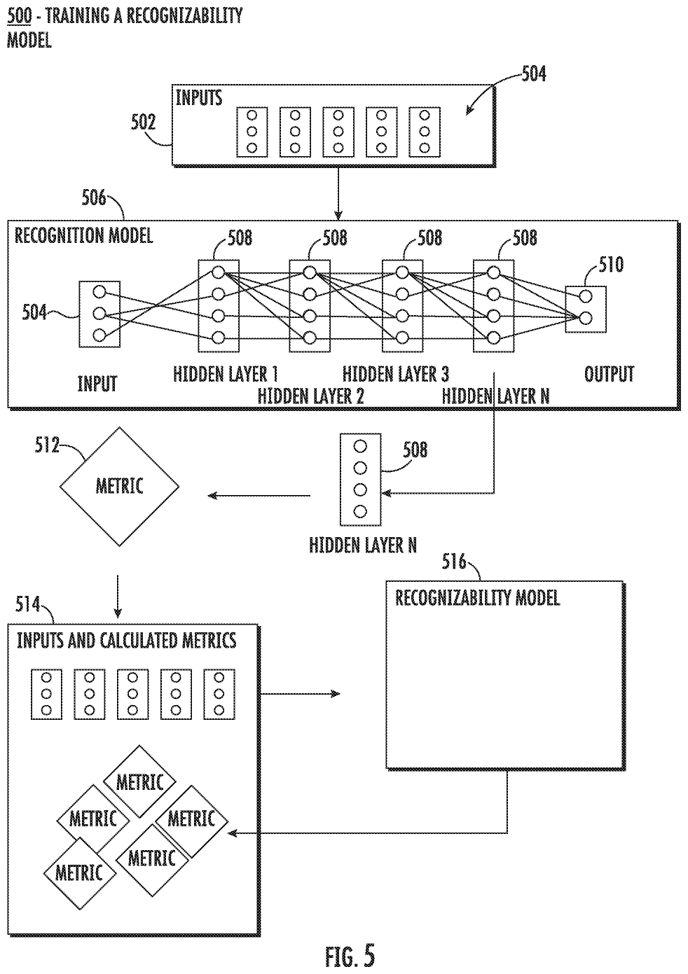

FIG. 5 illustrates an example aspect of certain methods and systems according to the present disclosure. For some implementations, the methods and systems may include a trained recognizability model and/or training a recognizability model. FIG. 5 illustrates a block flow diagram displaying an example method for training a recognizability model 500 according to the disclosure. FIG. 5 shows a plurality of inputs 502 being provided to a recognition model 506 configured as a neural network including a plurality of hidden layers 508. The recognition model 506 can generate the plurality of hidden layers 508 based in part on providing one of the inputs 504 to the recognition model 506. One or more of the hidden layers (e.g., hidden layer N 508) can then be extracted to determine a metric 512 such as the norm of the features included in the hidden layer 508. Continuing this process for each input 504 included in the plurality of inputs 502 can generate a calculated metric for each of the inputs. The set of inputs and calculated metrics 514 can then be used to train a recognizability model using a distillation technique. In this manner, the recognizability model can be trained to determine the calculated metric 512, based at least in part on receiving the respective input used to determine the metric 512. For some implementations, the recognition model 506 may be configured to not determine any further hidden layers 508 or an output 510 after generating the hidden layer 508 used to generate the metric 512. Thus the recognition model 506 used during training the recognizability model 500 need not be the same as the recognition model(s) included in the network of devices as depicted in FIG. 1A.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computing system, comprising:
an enrollment device comprising one or more processors and one or more non-transitory computer-readable media that collectively store instructions that, when executed by the one or more processors, configure the enrollment device to:
obtain a plurality of images that depict a user that is undergoing an enrollment process;
process each of the plurality of images using a machine-learned recognizability model to determine a respective recognizability score for each image as an output of the machine-learned recognizability model, wherein the recognizability score for each image is indicative of a recognizability of the user as depicted by the image and is exclusive of biometric information associated with the user;
select, based at least in part on the respective recognizability scores for the plurality of images, at least one of the plurality of images for inclusion in an image gallery associated with the user; and
directly or indirectly transmit the image gallery to one or more secondary computing devices for use in recognition of the user by the one or more secondary computing devices.

2. The computing system of claim 1, further comprising:
the one or more secondary computing devices configured to:
receive and store the image gallery;
obtain an additional image that depicts a person; and
compare the additional image to the image gallery to determine whether the person depicted in the additional image is the user.

3. The computing system of claim 1, wherein the one or more secondary computing devices comprise a server computing device.

4. The computing system of claim 1, wherein the one or more secondary computing devices comprise a computer assistant device.

5. The computing system of claim 1, wherein the one or more secondary computing devices comprise a server computing device configured to:
receive the image gallery from the enrollment device; and
selectively forward the image gallery to one or more additional devices in response to a request from the user to enroll the one or more additional devices with a user account associated with the user.

6. The computing system of claim 1, wherein the enrollment device comprises a user device associated with the user.

7. The computing system of claim 1, wherein the enrollment device comprises a server computing device, and wherein the server computing obtains the plurality of images from a user device that captured the plurality of images and that is associated with the user.

8. The computing system of claim 1, wherein each of the one or more secondary computing devices are configured to process each of the images included in the image gallery using a machine-learned facial recognition model that obtain a facial embedding for the image, the facial embedding inclusive of the biometric information associated with the user.

9. The computing system of claim 1, wherein the machine-learned recognizability model has been learned through a distillation training technique in which the machine-learned recognizability model is trained to predict a norm of a hidden layer output generated by a hidden layer of a machine-learned facial recognition model that is configured to produce a facial embedding for an input image.

10. A computer-implemented method for enrolling in personal identification across a network of devices, the method comprising:
obtaining, by one or more computing devices, a dataset comprising one or more files representative of a person on a first device;
determining, by the one or more computing devices, a recognizability score for each of the one or more files by providing each file to a machine-learned distillation model, wherein the distillation model has been trained using a metric calculated from one or more hidden layers of a neural network; and
selecting, by the one or more computing devices and based at least in part on the recognizability score, a portion of the dataset to store as a reference file or files for the person.

11. The computer-implemented method of claim 10, wherein selecting the portion of the dataset to store as the reference file or files comprises:
comparing, by the one or more computing devices, the recognizability score for each of the one or more files to a threshold; and
when none of the recognizability scores satisfy the threshold:
providing, by the one or more computing devices, a prompt on the first device that requests that the person generate additional files;
when the recognizability score for one or more files included the dataset satisfies the threshold:
transmitting, by the one or more computing devices, said file or files to a second device.

12. The computer-implemented method of claim 11, wherein:
the second device comprises a cloud computing device or a server computing device, and wherein the second device is in communication with at least one other device included in the network of devices via a communications network.

13. The computer-implemented method of claim 10, further comprising:
attempting, by the one or more computing devices, to access one of the devices included in the network of devices, an operation performed by one of the devices, or both, wherein attempting to access includes performing, by the one or more computing devices, a biometric analysis that comprises:
obtaining, by the one or more computing devices, a signal comprising information representative of the person;
accessing, by the one or more computing devices, the reference file or files;
comparing, by the one or more computing devices, the reference file or files to the signal; and
providing, by the one or more computing devices and based at least in part on comparing the reference file to the signal, a response that permits or denies the attempt to access.

14. The computer-implemented method of claim 13, wherein obtaining, by the one or more computing devices, the signal comprising information representative of the person comprises obtaining, by a third device, the signal comprising information representative of the person.

15. The computer-implemented method of claim 14, wherein the third device comprises a computer assistant configured to receive an input comprising at least one of visual, audio, or text input; and, based at least in part on said input, provide an output.

16. The computer-implemented method claim 13, wherein comparing the reference file or files to the set of files comprises:
determining, by the one or more computing devices, a set of biometric information by providing the reference file or files to a machine-learned model.

17. The computer-implemented method of claim 16, wherein the machine-learned model comprises a neural network and the set of biometric information comprises an embedding produced by the neural network.

18. The computer-implemented method of claim 10, wherein the first device comprises a mobile computing device.

19. The computer-implemented method of claim 10, wherein the first device comprises a computer assistant configured to receive an input comprising at least one of visual, auto, or text; and, based at least in part on said input, provide an output.

20. (canceled)

21. The computer-implemented method of claim 10, wherein the first device is prohibited from computing a biometric identifier.

22-29. (canceled)
